(19) United States
(12) Patent Application Publication
(10) Pub. No.: US 2014/0340882 A1
(43) Pub. Date: Nov. 20, 2014

(54) BALLAST ADAPTER

(71) Applicants: Tom Woods, Hawthorne, CA (US); Kevin Yang, Lomita, CA (US); Alvaro Garcia, Hawthorne, CA (US); Fengchang Hu, Hawthorne, CA (US)

(72) Inventors: Tom Woods, Hawthorne, CA (US); Kevin Yang, Lomita, CA (US); Alvaro Garcia, Hawthorne, CA (US); Fengchang Hu, Hawthorne, CA (US)

(21) Appl. No.: 13/894,668

(22) Filed: May 15, 2013

(51) Int. Cl. F21V 21/005; F21V 19/00

(52) U.S. Cl. CPC F21V 21/005; F21V 19/0075
USPC 362/219

(57) ABSTRACT

A ballast adapter includes a bracket plate formed as a flat sheet having a bracket plate outside surface and a bracket plate inside surface. The ballast adapter also has a pair of bracket plate arms having a sliding mount to the bracket plate. The pair of bracket plate arms are mounted to slide adjust toward and away from each other. The pair of bracket plate arms includes a first bracket plate arm and a second bracket plate arm. A pair of bracket sidewalls extend in a direction at a generally normal plane from the pair of bracket plate arms. The pair of bracket sidewalls includes a first bracket sidewall and a second bracket sidewall. The first bracket sidewall extends from the first bracket plate arm and the second bracket sidewall extends from the second bracket plate arm.

### FIELD OF THE INVENTION

The present invention is in the field of fluorescent ballast adapters.

### DISCUSSION OF RELATED ART

As longer fluorescent tube light lengths are replaced by shorter florescent tube light lengths a variety of different ballast adapters have been implemented.

### SUMMARY OF THE INVENTION

A ballast adapter includes a bracket plate formed as a flat sheet having a bracket plate outside surface and a bracket plate inside surface. The ballast adapter also has a pair of bracket plate arms having a sliding mount to the bracket plate. The pair of bracket plate arms are mounted to slide adjust toward and away from each other. The pair of bracket plate arms includes a first bracket plate arm and a second bracket plate arm. A pair of bracket sidewalls extend in a direction at a generally normal plane from the pair of bracket plate arms. The pair of bracket sidewalls includes a first bracket sidewall and a second bracket sidewall. The first bracket sidewall extends from the first bracket plate arm and the second bracket sidewall extends from the second bracket plate arm.

The ballast adapter also includes a ballast mounted to the bracket plate inside surface and ballast wires extending from the ballast. The ballast wires are for carrying electrical power to the ballast. A middle socket is mounted to the bracket plate. The middle socket includes a socket body having a socket slot. The socket slot is an electrical connector.

Optionally, a pair of bracket risers are formed on the bracket plate inside surface. The pair of bracket risers have a pair of bracket riser openings. The pair of bracket risers includes a first bracket riser and a second bracket riser. The pair of bracket riser openings are threaded for receiving a threaded connection. The pair of bracket riser openings includes a first bracket riser opening formed on the first bracket riser and a second bracket register opening formed on the second bracket riser. The ballast has a pair of ballast flanges, namely a first ballast flange and a second ballast flange. The first ballast flange has a first ballast flange notch and the second ballast flange has a second ballast flange notch. A distance between the first ballast flange notch and the second ballast flange notch is sized to match a distance between the first bracket riser opening and the second bracket riser opening. The bracket plate is formed with more than one ballast clip that receives an edge of a ballast flange. The bracket plate arms include one or more bracket ratchet teeth for maintaining a span of the bracket plate arms during installation so that the bracket plate arms do not slide freely while an installer is handling the bracket plate arms.

The first bracket sidewall that extends from the first bracket plate arm has a first bracket sidewall opening and the second bracket sidewall that extends from the second bracket plate arm has a second bracket sidewall opening. End sockets can be mounted on a pair of end socket plates. The bracket pawl is preferably formed on the bracket plate. The bracket pawl engages the first bracket plate arm to inhibit free sliding of the bracket plate. The bracket pawl can be form by a protrusion on the bracket plate. The first bracket pawl can be formed on the first bracket plate arm and a second bracket pawl formed on the second bracket plate arm. The first bracket pawl and the second bracket pawl can engage with each other to inhibit free sliding of the first bracket plate arm and the second bracket plate arm.

### BRIEF DESCRIPTION OF THE DRAWINGS

FIG. 1 is a bottom exploded perspective view showing the ballast detached from the ballast plate.

FIG. 2 is a bottom perspective view showing the ballast attached to the ballast plate.

FIG. 3 is a top perspective view diagram showing the assembled configuration.

FIG. 4 is a top view of the present invention.

FIG. 5 is a bottom view of the present invention.

FIG. 6 is a bottom perspective view of a ballast having a slightly different shaped housing.

FIG. 7 is an exploded view of the present invention.

The following call out list of elements is a useful guide in referencing the callout numbering of the drawings.
20 Ballast
21 Ballast Flange
22 Ballast Flange Notch
23 Ballast Wire
24 Ballast Clip
30 Bracket
31 Bracket Plate
32 Bracket Riser
33 Bracket Riser Opening
34 Bracket Plate Arm
35 Bracket Sidewall
36 Bracket Ratchet Tooth
37 Bracket Sidewall Opening
38 Bracket Pawl
40 Middle Socket
41 Socket Body
42 Socket Snap Fit
43 Socket Slot
44 End Socket
45 End Socket Plate

### DETAILED DESCRIPTION OF THE PREFERRED EMBODIMENT

The ballast adapter includes a bracket 30. The bracket 30 has a bracket plate 31 shown as the horizontal plate in the figures. The bracket 30 also has a bracket riser 32. The bracket riser 32 purchased from a surface of the bracket plate to a set distance from the bracket plate. The bracket riser 32 has a bracket opening 33 for receiving a threaded screw through the bracket opening 33. The bracket opening 33 may have a threaded internal surface for screw connection to a ballast 20. The ballast has a pair of ballast flanges, namely a first ballast flange and a second ballast flange. The first ballast flange has a first ballast flange notch and the second ballast flange has a second ballast flange notch. A distance between the first ballast flange notch and the second ballast flange notch is sized to match a distance between the first bracket riser opening and the second bracket riser opening so that connector means such as a nut and bolt or nut without bolt can make connection between the ballast and the bracket.

The ballast 20 has a generally rectangular box body and may have a ballast connection means including a ballast flange 21. The ballast flange typically has a ballast connection location such as a ballast flange notch. The ballast 20 also has a ballast wire 23. The ballast 20 may be connected to the bracket 30 at a ballast clip 24. The ballast clip 24 can form a slot for receiving the ballast flange 21.

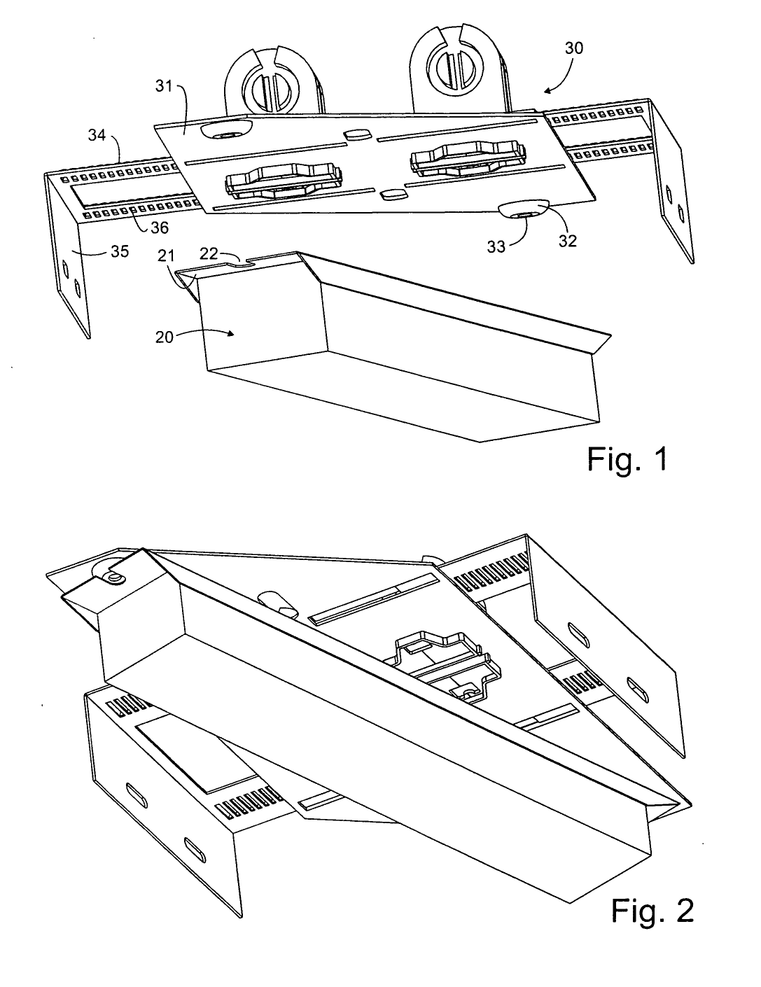

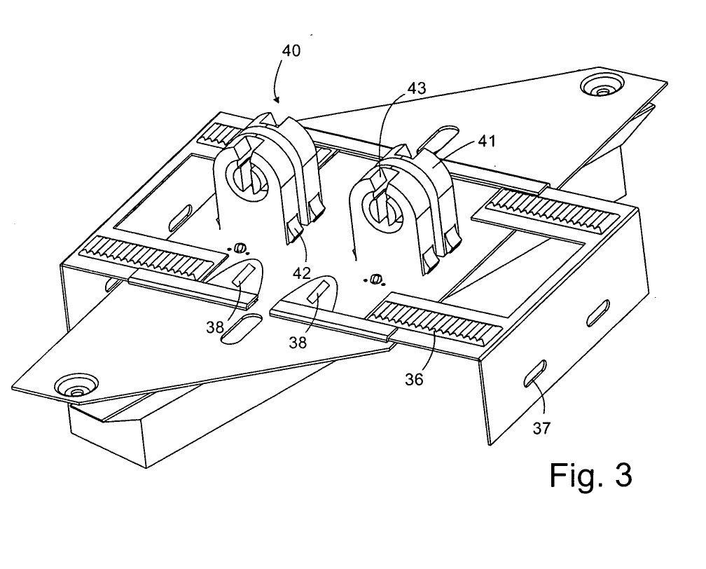

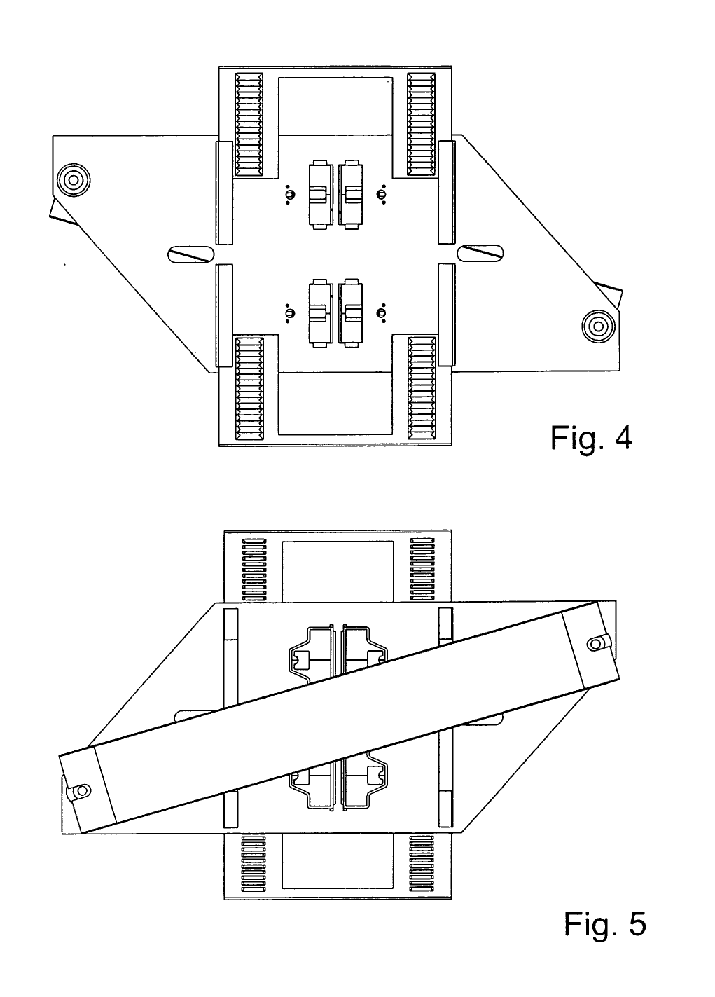

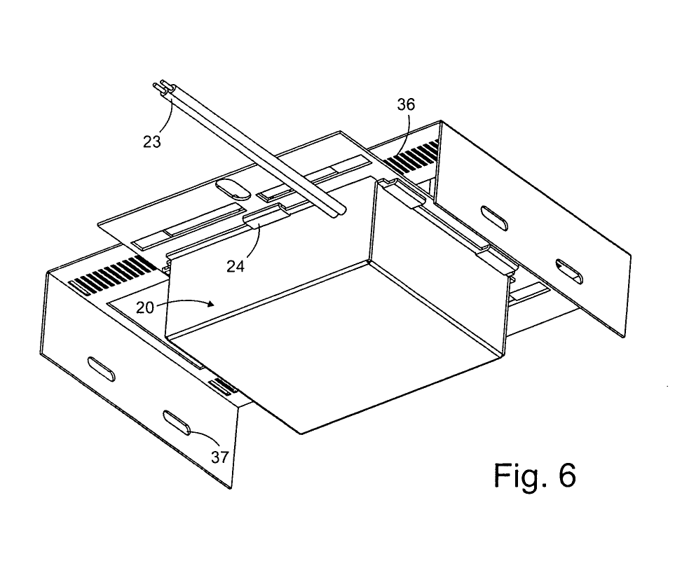

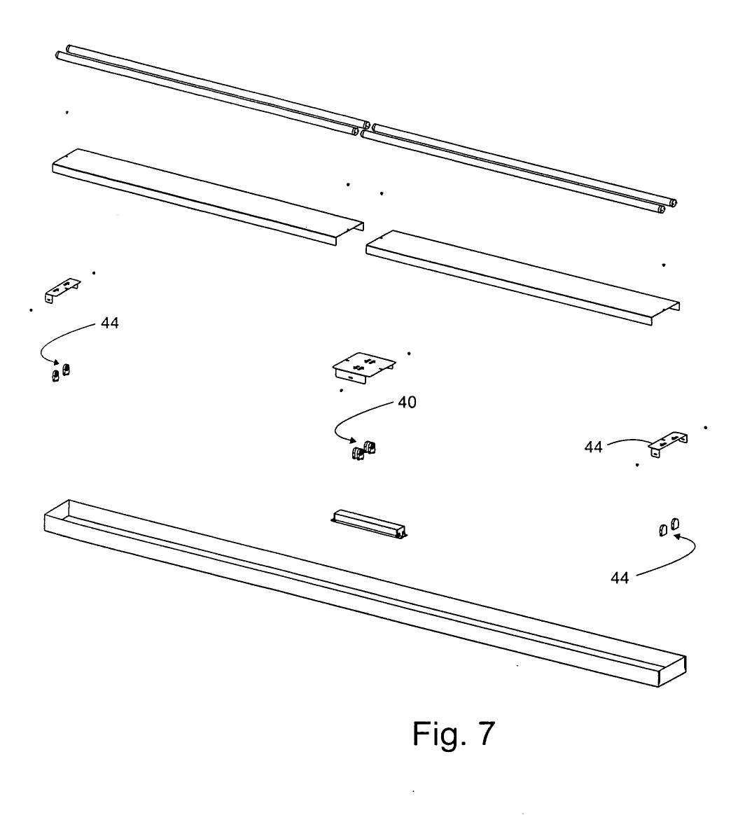

The ballast flange 21 can be extending from more than one sidewall of the ballast box body. The ballast can be made as an elongated box housing set at a diagonal angle from the bracket plate 31 as seen in FIGS. 1-5 or can be a box with a length and width more equal to each other such as the miniaturized ballast shown in FIG. 6.

The bracket plate 31 has a slot for receiving a pair of bracket plate arms 34. The bracket plate arms 34 extend downward at a pair of bracket sidewalls 35. The bracket plate arms 34 can be moved in a sliding fashion toward each other or a way from each other so as to increase the span of the ballast adapter. The ballast adapter has a span extending from an outside surface of the first bracket sidewall to an outside surface of a second bracket sidewall.

The span of the bracket plate 31 adjustable by the bracket plate arms is locked into position preferably using screws that are self tapping screws fitting through the racket sidewall opening 37 so as to secure to a sidewall of a fluorescent ballast housing fixture. The bracket plate arms optionally include rows of bracket ratchet tooth 36 that can interference fit against each other or against a bracket pawl 38. The bracket pawl 38 can be formed as a protrusion or opening on either the bracket plate 31 or on the.

Preferably, four middle sockets 40 are mounted to the ballast adapter. The four middle sockets 40 preferably power four fluorescent tube light bulbs. The middle sockets 40 have a socket body 41 typically made of plastic. The socket body 41 also includes a socket snap fit 42 to align and affix socket slot 43 to the bracket plate 31. The socket slot 43 can be formed by injection molding and is designed to receive a pair of electrical connector pins that extend into the slots for powering the florescent tube.

The ballast adapter could also have four opposing socket slots also called end sockets 44. The opposing socket slots can be wired to each other such that car passes from one of the middle sockets 40 to one of the outside sockets and then returned back to an adjacent middle socket 40. The end sockets 44 can be mounted to end socket plates 45.

The bracket plate 31 can have a pair of cut corners adjacent to the bracket riser 32. The cut corners make the otherwise rectangular bracket plate 31 a six sided polygon shape.

1. A ballast adapter comprising:
a. bracket plate formed as a flat sheet having a bracket plate outside surface and a bracket plate inside surface;
b. a pair of bracket plate arms having a sliding mount to the bracket plate, wherein the pair of bracket plate arms are mounted to slide adjust toward and away from each other, wherein the pair of bracket plate arms includes a first bracket plate arm and a second bracket plate arm;
c. a pair of bracket sidewalls extending in a direction at a generally normal plane from the pair of bracket plate arms, wherein the pair of bracket sidewalls includes a first bracket sidewall and a second bracket sidewall, wherein the first bracket sidewall extends from the first bracket plate arm and wherein the second bracket sidewall extends from the second bracket plate arm;
d. a ballast mounted to the bracket plate inside surface;
e. ballast wires extending from the ballast, wherein the ballast wires are for carrying electrical power to the ballast; and
f. a middle socket mounted to the bracket plate, wherein the middle socket includes a socket body having a socket slot, wherein the socket slot is an electrical connector.

2. The ballast adapter of claim 1 further comprising: a pair of bracket risers formed on the bracket plate inside surface, wherein the pair of bracket risers have a pair of bracket riser openings, wherein the pair of bracket risers comprises a first bracket riser and a second bracket riser.

3. The ballast adapter of claim 2, wherein the pair of bracket riser openings are threaded for receiving a threaded connection, wherein the pair of bracket riser openings includes a first bracket riser opening formed on the first bracket riser and a second bracket register opening formed on the second bracket riser.

4. The ballast adapter of claim 1, wherein the ballast has a pair of ballast flanges, namely a first ballast flange and a second ballast flange, wherein the first ballast flange has a first ballast flange notch and wherein the second ballast flange has a second ballast flange notch, wherein a distance between the first ballast flange notch and the second ballast flange notch is sized to match a distance between the first bracket riser opening and the second bracket riser opening.

5. The ballast adapter of claim 1, wherein the bracket plate is formed with more than one ballast clip that receives an edge of a ballast flange.

6. The ballast adapter of claim 1, wherein the bracket plate arms further include one or more bracket ratchet teeth for maintaining a span of the bracket plate arms during installation.

7. The ballast adapter of claim 1, wherein the first bracket sidewall that extends from the first bracket plate arm has a first bracket sidewall opening and wherein the second bracket sidewall that extends from the second bracket plate arm has a second bracket sidewall opening.

8. The ballast adapter of claim 7, further comprising an end socket and an end socket plate.

9. The ballast adapter of claim 1, further comprising a bracket pawl formed on the bracket plate, wherein the bracket pawl engages the first bracket plate arm to inhibit free sliding of the bracket plate.

10. The ballast adapter of claim 1, further comprising a first bracket pawl formed on the first bracket plate arm and a second bracket pawl formed on the second bracket plate arm wherein the first bracket pawl and the second bracket pawl engage with each other to inhibit free sliding of the first bracket plate arm and the second bracket plate arm.

11. The ballast adapter of claim 1 further comprising: a pair of bracket risers formed on the bracket plate inside surface, wherein the pair of bracket risers have a pair of bracket riser openings, wherein the pair of bracket risers comprises a first bracket riser and a second bracket riser, wherein the pair of bracket riser openings are threaded for receiving a threaded connection, wherein the pair of bracket riser openings includes a first bracket riser opening formed on the first bracket riser and a second bracket register opening formed on the second bracket riser, wherein the ballast has a pair of ballast flanges, namely a first ballast flange and a second ballast flange, wherein the first ballast flange has a first ballast flange notch and wherein the second ballast flange has a second ballast flange notch, wherein a distance between the first ballast flange notch and the second ballast flange notch is sized to match a distance between the first bracket riser opening and the second bracket riser opening.

12. The ballast adapter of claim 11, wherein the bracket plate is formed with more than one ballast clip that receives an edge of a ballast flange.

13. The ballast adapter of claim 11, wherein the bracket plate arms further include one or more bracket ratchet teeth for maintaining a span of the bracket plate arms during installation.

14. The ballast adapter of claim 11, wherein the first bracket sidewall that extends from the first bracket plate arm has a first bracket sidewall opening and wherein the second bracket sidewall that extends from the second bracket plate arm has a second bracket sidewall opening.

15. The ballast adapter of claim 11, further comprising an end socket and an end socket plate.

16. The ballast adapter of claim 11, further comprising a bracket pawl formed on the bracket plate, wherein the bracket pawl engages the first bracket plate arm to inhibit free sliding of the bracket plate.

17. The ballast adapter of claim 11, further comprising a first bracket pawl formed on the first bracket plate arm and a second bracket pawl formed on the second bracket plate arm wherein the first bracket pawl and the second bracket pawl engage with each other to inhibit free sliding of the first bracket plate arm and the second bracket plate arm.
